(19) United States
(12) Patent Application Publication
(10) Pub. No.: US 2015/0036072 A1
(43) Pub. Date: Feb. 5, 2015

(54) LIQUID CRYSTAL DISPLAY

(71) Applicant: Samsung Display Co., Ltd., Yongin-City (KR)

(72) Inventors: Se Hyoung CHO, Hwaseong-si (KR); IL Gon KIM, Seoul (KR); Sang Jin JEON, Suwon-si (KR); Mee Hye JUNG, Suwon-si (KR); In-Jae HWANG, Suwon-si (KR)

(21) Appl. No.: 14/323,181

(22) Filed: Jul. 3, 2014

(30) Foreign Application Priority Data
Aug. 2, 2013 (KR) 10-2013-0092161

(51) Int. Cl. G02F 1/1362

(52) U.S. Cl. CPC G02F 1/13624; G02F 1/136286
USPC 349/43

(57) ABSTRACT

A liquid crystal display includes a first insulation substrate; a gate line disposed on the first insulation substrate; a dividing reference voltage line disposed on the first insulation substrate; and a data line disposed on the first insulation substrate; a first switching element connected to the gate line, the data line and a first liquid crystal capacitor; a second switching element connected to the gate line, the data line and a second liquid crystal capacitor; a third switching element connected to the gate line, the second liquid crystal capacitor and the third liquid crystal capacitor; and a fourth switching element connected to the gate line, a third liquid crystal capacitor and the dividing reference voltage line.

This application claims priority to Korean Patent Application No. 10-2013-0092161, filed on Aug. 2, 2013, and all the benefits accruing therefrom under 35 U.S.C. §119, the content of which in its entirety is herein incorporated by reference.

### BACKGROUND

(a) Field

Exemplary embodiments of the invention relate to a liquid crystal display.

(b) Description of the Related Art

A liquid crystal display, which is one of the most widely used type of flat panel display, typically includes two display panels, on which field generating electrodes such as pixel electrodes and common electrodes are provided, and a liquid crystal layer interposed therebetween.

The liquid crystal display applies a voltage to the field generating electrode to generate an electric field in the liquid crystal layer to control alignment of liquid crystal molecules of the liquid crystal layer, and the polarization of the incident light is thereby controlled to display images.

The liquid crystal display further includes a switching element which is connected to each of the pixel electrodes and a plurality of signal lines which controls the switching element to apply a voltage to the pixel electrode, such as a gate line and a data line.

Among the liquid crystal displays, a vertically aligned (“VA”) mode liquid crystal display in which major axes of the liquid crystal molecules are arranged to be substantially vertical to the display panel in a status, where an electric field is not applied, is getting spotlight due to a large contrast ratio and a large reference viewing angle. Here, the reference viewing angle refers to a viewing angle with a contrast ratio of 1:10 or a luminance inversion critical angle between gray scales.

In such a liquid crystal display, a method that divides one pixel into two sub-pixels and applies different voltages to the two sub-pixels to vary the transmittance may be used to allow the side visibility to be close to the front visibility.

### SUMMARY

Exemplary embodiments of the invention provide a liquid crystal display which reduces the cost of manufacturing a data driver while allowing the side visibility to be substantially close to the front visibility.

An exemplary embodiment of a liquid crystal display, according to the invention, includes a first insulation substrate; a gate line disposed on the first insulation substrate; a dividing reference voltage line disposed on the first insulation substrate; a data line disposed on the first insulation substrate; a first switching element connected to the gate line, the data line and a first liquid crystal capacitor; a second switching element connected to the gate line, the data line and a second liquid crystal capacitor, a third switching element connected to the gate line, the second liquid crystal capacitor and a third liquid crystal capacitor; and a fourth switching element connected to the gate line, the third liquid crystal capacitor and the dividing reference voltage line.

In an exemplary embodiment, a control terminal of the third switching element may be connected to the gate line, an input terminal of the third switching element may be connected to the second liquid crystal capacitor, and an output terminal of the third switching element may be connected to the third liquid crystal capacitor.

In an exemplary embodiment, a control terminal of the fourth switching element may be connected to the gate line, an input terminal of the fourth switching element may be connected to the third liquid crystal capacitor, and an output terminal of the fourth switching element may be connected to the dividing reference voltage line.

In an exemplary embodiment, a control terminal of the first switching element may be connected to the gate line, an input terminal of the first switching element may be connected to the data line, and an output terminal of the first switching element may be connected to the first liquid crystal capacitor.

In an exemplary embodiment, a control terminal of the second switching element may be connected to the gate line, an input terminal of the second switching element may be connected to the data line, and an output terminal of the second switching element may be connected to the second liquid crystal capacitor.

In an exemplary embodiment, the liquid crystal display may further include a fifth switching element connected between the gate line, the second liquid crystal capacitor and the third liquid crystal capacitor, a control terminal of the fifth switching element may be connected to the gate line, an input terminal of the fifth switching element may be connected to the second liquid crystal capacitor, and an output terminal of the fifth switching element may be connected to a fourth liquid crystal capacitor and the input terminal of the fourth switching element.

Another exemplary embodiment of a liquid crystal display, according to the invention, includes a first insulation substrate; a gate line disposed on the first insulation substrate; a dividing reference voltage line disposed on the first insulation substrate; a gate insulating layer disposed on the gate line and the dividing reference voltage line; a first semiconductor, a second semiconductor, a third semiconductor and a fourth semiconductor disposed on the gate insulating layer; a data line including a first source electrode, a first drain electrode, a second source electrode, a second drain electrode, a third source electrode, a third drain electrode, a fourth source electrode, and a fourth drain electrode, which are disposed on the first semiconductor, the second semiconductor, the third semiconductor and the fourth semiconductor; an insulating layer disposed on the data line, the first drain electrode, the second drain electrode, the third source electrode, the third drain electrode, the fourth source electrode and the fourth drain electrode; a pixel electrode disposed on the insulating layer and which includes a first sub-pixel electrode connected to the first drain electrode, a second sub-pixel electrode connected to the second drain electrode, and a third sub-pixel electrode connected to the third drain electrode; a second insulation substrate disposed opposite to the first insulation substrate; and a common electrode disposed on the second insulation substrate.

In an exemplary embodiment, the second drain electrode and the third source electrode may be connected to each other.

In an exemplary embodiment, the third drain electrode and the fourth source electrode may be connected to each other.

In an exemplary embodiment, the dividing reference voltage line may include a reference electrode, and the fourth drain electrode and the reference electrode may be connected to each other.

In an exemplary embodiment, the first sub-pixel electrode, the second sub-pixel electrode, the third sub-pixel electrode may be sequentially arranged in a direction substantially parallel to the data line.

In an exemplary embodiment, each of the first sub-pixel electrode, the second sub-pixel electrode and the third sub-pixel electrode may include a cross-shaped stem portion and a plurality of fine branch electrodes extending in a plurality of directions from the cross-shaped stem portion.

In an exemplary embodiment, the first sub-pixel electrode may be spaced apart from the second sub-pixel electrode and the third sub-pixel electrode, the third sub-pixel electrode may have a rhombus shape in a plan view, and the second sub-pixel electrode may enclose the third sub-pixel electrode.

In an exemplary embodiment, each of the first sub-pixel electrode and the third sub-pixel electrode may include a cross-shaped stem portion and a plurality of fine branch electrodes extending in a plurality of directions from the cross-shaped stem portion, and the second sub-pixel electrode may include a stem electrode disposed at an edge thereof, and a plurality of fine branch electrodes extending in a plurality of directions from the stem electrode.

According to exemplary embodiments of a liquid crystal display, according to the invention, the cost of manufacturing a data driver is substantially reduced while allowing the side visibility to be close to the front visibility.

### BRIEF DESCRIPTION OF THE DRAWINGS

The above and other features of the invention will become more apparent by describing in further detail exemplary embodiments thereof with reference to the accompanying drawings, in which:

FIG. 1 is an equivalent circuit diagram illustrating an exemplary embodiment of a pixel of a liquid crystal display, according to the invention;

FIG. 2 is a circuit diagram illustrating an exemplary embodiment of a driving method of a liquid crystal display, according to the invention;

FIG. 3 is a top plan view of an exemplary embodiment of a liquid crystal display, according to the invention;

FIG. 4 is a cross-sectional view taken along line IV-IV of the liquid crystal display shown in FIG. 3;

FIG. 5 is a cross-sectional view taken along line V-V of the liquid crystal display shown in FIG. 3;

FIG. 6 is a top plan view illustrating a unit electrode of a pixel electrode of an exemplary embodiment of the liquid crystal display, according to the invention;

FIG. 7 is a diagram illustrating an exemplary embodiment of a process that allows the liquid crystal molecules to be pre-tilted using a prepolymer, which is polymerized by light such as ultraviolet rays;

FIG. 8 is a top plan view of an alternative exemplary embodiment of a liquid crystal display, according to the invention;

FIG. 9 is a cross-sectional view taken along line IX-IX of the liquid crystal display shown in FIG. 8;

FIG. 10 is a cross-sectional view taken along the line X-X of the liquid crystal display shown in FIG. 8;

FIG. 11 is an equivalent circuit diagram illustrating an alternative exemplary embodiment of a pixel of a liquid crystal display, according to the invention; and

FIGS. 12 and 13 are graphs illustrating a result of an experimental example of a conventional liquid crystal display and an exemplary embodiment of a liquid crystal display according to the invention, respectively.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, exemplary embodiments of the invention will be described with reference to the accompanying drawings.

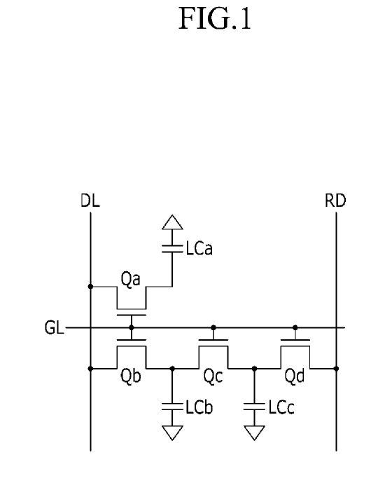

First, an arrangement of signal lines and pixels of an exemplary embodiment of a liquid crystal display according to the invention will be described with reference to FIG. 1. FIG. 1 is an equivalent circuit diagram illustrating an exemplary embodiment of a pixel of a liquid crystal display, according to the invention.

Referring to FIG. 1, a pixel of an exemplary embodiment of the liquid crystal display includes a plurality of signal lines, which includes a gate line GL that transmits a gate signal, a data line DL that transmits a data signal and a dividing reference voltage line RD that transmits a divided reference voltage, a first switching element Qa, a second switching element Qb, a third switching element Qc and a fourth switching element Qd, which are connected to the plurality of signal lines, and a first liquid crystal capacitor LCa, a second liquid crystal capacitor LCb and a third liquid crystal capacitor LCc.

The first switching element Qa and the second switching element Qb are connected to the gate line GL and data line DL, respectively. The third switching element Qc is connected to the gate line GL and an output terminal of the second switching element Qb and the fourth switching element Qd is connected to the gate line GL and the dividing reference voltage line RD.

The first switching element Qa and the second switching element Qb are each a three-terminal element, such as a thin film transistor, and a control terminal thereof is connected to the gate line GL and an input terminal thereof is connected to the data line DL. An output terminal of the first switching element Qa is connected to the first liquid crystal capacitor LCa, and an output terminal of the second switching element Qb is connected to the second liquid crystal capacitor LCb and an input terminal of the third switching element Qc.

The third switching element Qc is also a three terminal element, such as a thin film transistor. A control terminal of the third switching element Qc is connected to the gate line GL, an input terminal of the third switching element Qc is connected to the second liquid crystal capacitor LCb, and an output terminal of the third switching element Qc is connected to the third liquid crystal capacitor LCc.

The fourth switching element Qd is also a three terminal element such as a thin film transistor. A control terminal of the fourth switching element Qd is connected to the gate line GL, an input terminal of the fourth switching element Qd is connected to the third liquid crystal capacitor LCc, and an output terminal of the fourth switching element Qd is connected to the dividing reference voltage line RD.

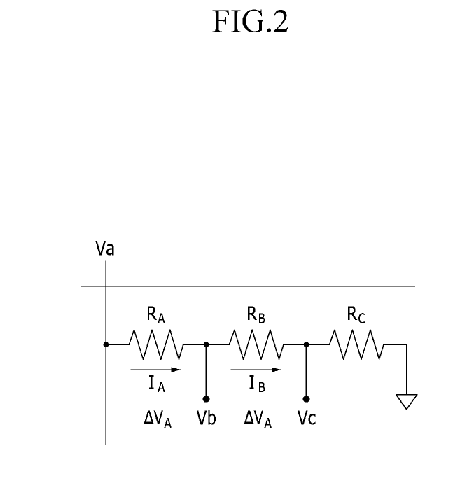

Now, an exemplary embodiment of a driving method of the liquid crystal display, according to the invention, will be described with reference to FIGS. 1 and 2. FIG. 2 is a circuit diagram illustrating an exemplary embodiment of a driving method of a liquid crystal display, according to the invention.

First, referring to FIG. 1, when a gate-on signal is supplied to the gate line GL, the first switching element Qa, the second switching element Qb, the third switching element Qc and the fourth switching element Qd, which are connected to the gate line GL, are turned on, such that the data voltage, which is applied to the data line DL, is applied to a first sub-pixel electrode and a second sub-pixel electrode through the turned-on first switching element Qa and second switching element Qb. In such an embodiment, the data voltages which are applied to the first sub-pixel electrode and the second sub-pixel electrode are equal to each other, and the first liquid crystal capacitor LCa and the second liquid crystal capacitor LCb are charged with a value which are equal to the difference between a common voltage and the data voltage. When the first liquid crystal capacitor LCa and the second liquid crystal capacitor LCb are charged, the voltage charged in the second liquid crystal capacitor LCb is divided by the turned-on third switching element Qc to be charged in the third liquid crystal capacitor LCc, and the voltage charged in the third liquid crystal capacitor LCc is divided by the turned-on fourth switching element Qd. Accordingly, in such an embodiment, a value of the voltage which is charged in the second liquid crystal capacitor LCb becomes lower than a value of the voltage which is charged in the first liquid crystal capacitor LCa, and a value of the voltage which is charged in the third liquid crystal capacitor LCc becomes lower than a value of a voltage which is charged in the second liquid crystal capacitor LCb.

Now, referring to FIGS. 1 and 2, a voltage dividing method will be described in detail. Hereinafter, a voltage applied through the data line DL is referred to as a first voltage Va, a voltage which is applied to the output terminal of the second switching element Qb to be charged in the second liquid crystal capacitor LCb is referred to as a second voltage Vb, and a voltage which is applied to the output terminal of the third switching element Qc to be charged in the third liquid crystal capacitor LCc is referred to as a third voltage Vc.

Amplitude of a first current I_{A} that flows in a second switching element Qb, which is a first resistor R_{A}, is proportional to a first channel width (W_{A}) of the second switching element Qb and is inversely proportional to a first channel length (L_{A}) thereof.

$${I}_{A} ∝ \frac{{W}_{A}}{{L}_{A}}$$

Similarly, amplitude of a second current I_{B} that flows in a third switching element Qc, which is a second resistor R_{B}, is proportional to a second channel width (W_{B}) of the third switching element Qc and is inversely proportional to a second channel length (L_{B}) thereof.

$${I}_{B} ∝ \frac{{W}_{B}}{{L}_{B}}$$

A resistance value is inversely proportional to a value of the current, and thus satisfies the following Equations.

$${R}_{A} ∝ \frac{{L}_{A}}{{W}_{A}}$$

$${R}_{B} ∝ \frac{{L}_{B}}{{W}_{B}}$$

When a difference between the first voltage Va and a value of the divided reference voltage is referred to as a divided voltage ΔV, a first reduced voltage value ΔV_{A}, which is decreased while passing through the second switching element Qb, satisfies the following equations.

$$Δ {V}_{A} = \frac{{R}_{A}}{{R}_{A} + {R}_{B}} Δ V ∝ \frac{\frac{{L}_{A}}{{W}_{A}}}{\frac{{L}_{A}}{{W}_{A}} + \frac{{L}_{B}}{{W}_{B}}}$$

$$Δ {V}_{A} = \frac{\frac{1}{{W}_{A}}}{\frac{{W}_{A} + {W}_{B}}{{W}_{A} {W}_{B}}} Δ V = \frac{{W}_{B}}{{W}_{A} + {W}_{B}} Δ V$$

The second voltage Vb, which is applied to the output terminal of the second switching element Qb to be charged in the second liquid crystal capacitor LCb, has a value obtained by subtracting the first reduced voltage value ΔV_{A} from the input first voltage Va.

Therefore, the second voltage Vb satisfies the following equations:

$$Vb = Va - Δ {V}_{A}$$

$$\frac{Vb}{Va} = 1 - \frac{{W}_{B}}{{W}_{A} + {W}_{B}} \frac{Δ V}{Va} = \frac{{W}_{A}}{{W}_{A} + {W}_{B}} \frac{Δ V}{Va} .$$

If the divided reference voltage value is equal to the common voltage, a value of the divided voltage ΔV is equal to the first voltage Va.

Therefore, the following equation is satisfied.

$$\frac{Vb}{Va} = \frac{{W}_{A}}{{W}_{A} + {W}_{B}}$$

As a result, the second voltage Vb which is applied to the output terminal of the second switching element Qb to be charged in the second liquid crystal capacitor LCb satisfies the following equation.

$$Vb = \frac{{W}_{A}}{{W}_{A} + {W}_{B}} Va$$

Similarly, a third voltage Vc, which is applied to the output terminal of the third switching element Qc to be charged in the third liquid crystal capacitor LCc, satisfies the following equation with respect to the second channel width (W_{B}) of the third switching element Qc which is a second resistor R_{B} and a third channel width (W_{C}) of the fourth switching element Qd which is a third resistor R_{C}.

$$Vc = \frac{{W}_{B}}{{W}_{B} + {W}_{C}} Vb$$

Accordingly, the second voltage Vb which is charged in the second liquid crystal capacitor LCb becomes lower than the first voltage Va which is charged in the first liquid crystal capacitor LCa through the data line DL, and the third voltage Vc which is charged in the third liquid crystal capacitor LCc becomes lower than the second voltage Vb which is charged in the second liquid crystal capacitor LCb.

In such an embodiment, the second voltage Vb, which is charged in the second liquid crystal capacitor LCb, and the third voltage Vc, which is charged in the third liquid crystal capacitor LCc, may vary based on a difference in channel widths of the second switching element Qb and the third switching element Qc and a difference in channel widths of the third switching element Qc and the fourth switching element Qd.

In a conventional liquid crystal display, where the side visibility is close to the front visibility by dividing one pixel into two sub-pixels and varying the transmittance, it is difficult to represent the gray scale at the side and thus an image quality is deteriorated. In such a conventional liquid crystal display, as the number of data lines which apply the data voltage to the pixels of the liquid crystal display is increased, the cost for a data driver is increased, thereby increasing the cost for the liquid crystal display.

In an exemplary embodiment of the invention, as described above, a pixel area includes the first liquid crystal capacitor LCa, the second liquid crystal capacitor LCb and the third liquid crystal capacitor LCc, in which different voltages are charged, such that electric fields having different values are applied to the liquid crystal molecules corresponding to the first liquid crystal capacitor LCa, the second liquid crystal capacitor LCb and the third liquid crystal capacitor LCc. Accordingly, in such an embodiment, inclination angles of the liquid crystal molecules in regions of a pixel area are different from each other, such that the luminance of the regions becomes various. Therefore, in such an embodiment, a pixel area is divided into three regions having different luminances, and the change in the transmittance in accordance with the gray scale is thereby gradually controlled such that the transmittance is effectively prevented from being sharply changed in accordance with the change of the gray scale at the side. Therefore, the gray scale may be accurately represented while allowing the side visibility to be substantially close to the front visibility. In such an embodiment, a single data line is used to apply the data signal to a single pixel area such that a cost for manufacturing a data driver may be substantially reduced.

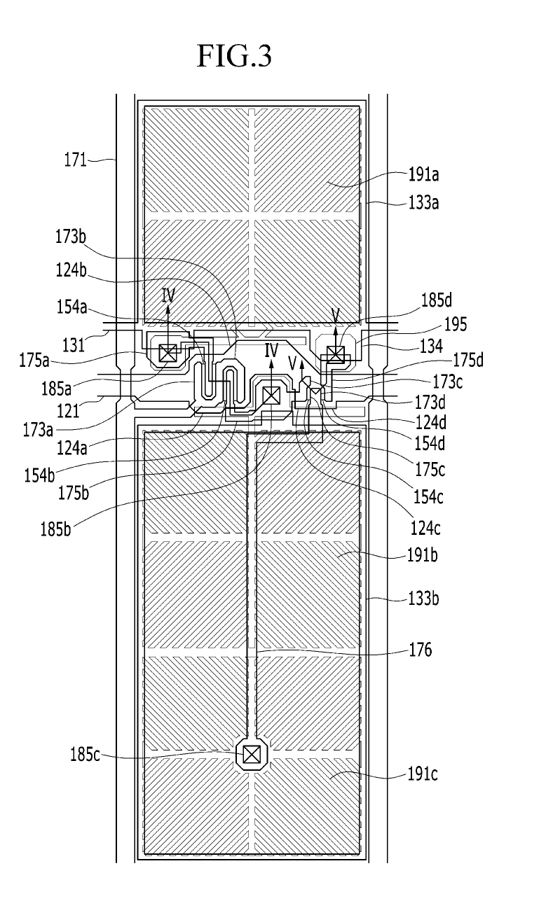

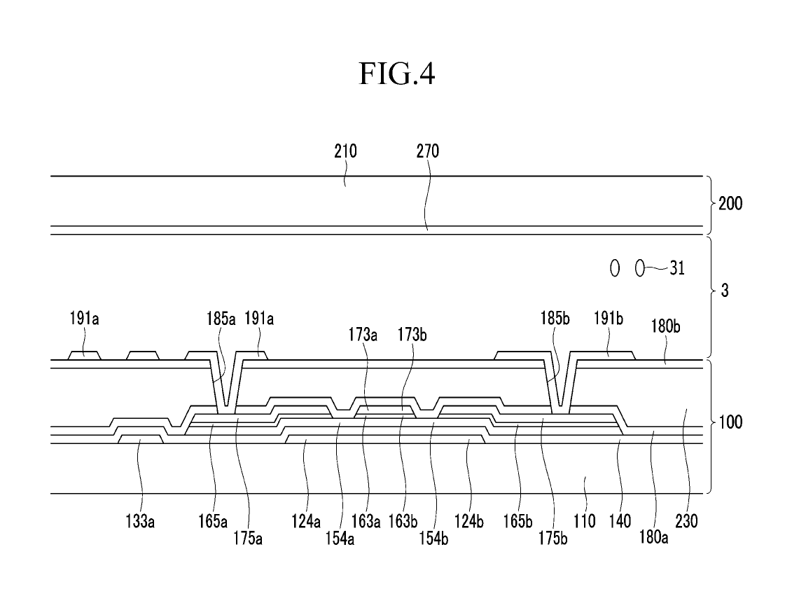

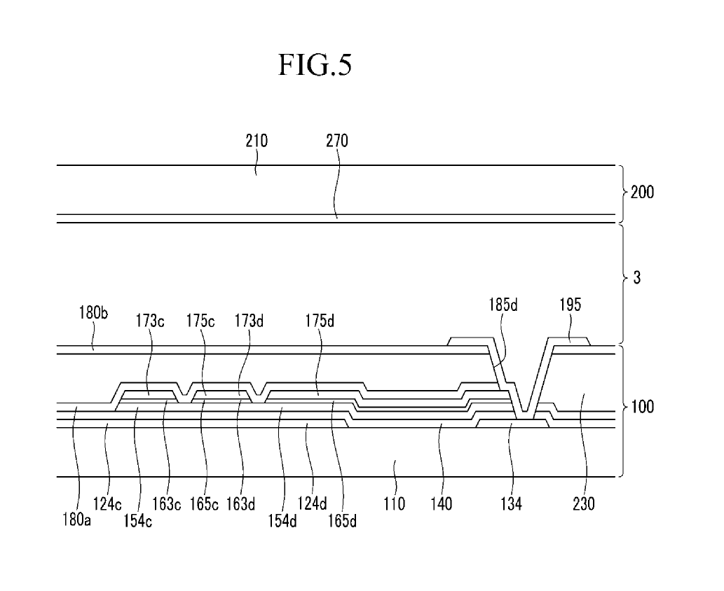

Now, a structure of an exemplary embodiment of the liquid crystal display, according to the invention, will be described in detail with reference to FIGS. 3 to 5. FIG. 3 is a top plan view of an exemplary embodiment of a liquid crystal display, according to the invention, FIG. 4 is a cross-sectional view taken along line IV-IV of the liquid crystal display shown in FIG. 3, and FIG. 5 is a cross-sectional view taken along line V-V of the liquid crystal display shown in FIG. 3.

Referring to FIGS. 3 to 5, an exemplary embodiment of the liquid crystal display includes two display panels, e.g., a lower panel 100 and an upper panel 200, which oppose to each other, a liquid crystal layer 3 interposed between the two display panels 100 and 200, and a pair of polarizers (not illustrated) which is attached to outer surfaces of the two display panel 100 and 200.

First, the lower panel 100 will be described in detail.

In the lower panel 100, a gate conductor which includes a gate line 121 and a dividing reference voltage line 131 is disposed on a first insulation substrate 110 which includes a transparent material, such as glass or plastic, for example.

The gate line 121 includes a first gate electrode 124a, a second gate electrode 124b, a third gate electrode 124c, a fourth gate electrode 124d and a gate pad (not illustrated) for connection with another layer or an external driving circuit.

The dividing reference voltage line 131 includes a first storage electrode 133a and a reference electrode 134. A second storage electrode 133b, which is not connected to the dividing reference voltage line 131 and overlaps a second sub-pixel electrode 191b, is disposed on the first insulation substrate 110.

A gate insulating layer 140 is disposed on the gate line 121 and the dividing reference voltage line 131.

A first semiconductor 154a, a second semiconductor 154b, a third semiconductor 154c and a fourth semiconductor 154d are disposed on the gate insulating layer 140.

A plurality of ohmic contacts 163a, 165a, 163b, 165b, 163c, 165c, 163d and 165d is disposed on the first to fourth semiconductors 154a, 154b, 154c and 154d.

A plurality of data conductors including a plurality of data lines 171, which includes a first source electrode 173a and a second source electrode 173b, a first drain electrode 175a, a second drain electrode 175b, a third source electrode 173c, the third drain electrode 175c, a fourth source electrode 173d and a fourth drain electrode 175d, is disposed on the ohmic contacts 163a, 165a, 163b, 165b, 163c, 165c, 163d and 165d, and the gate insulating layer 140.

The data conductors, and the semiconductors and the ohmic contacts, which are disposed below the data conductors, may be provided using a same mask.

The data line 171 includes a data pad (not illustrated) for connection with another layer or an external driving circuit.

The first gate electrode 124a, the first source electrode 173a and the first drain electrode 175a collectively define a first thin film transistor Qa, which is a first switching element Qa, together with the first semiconductor 154a, and a channel of the first thin film transistor is formed in the semiconductor 154a between the first source electrode 173a and the first drain electrode 175a. In such an embodiment, the second gate electrode 124b, the second source electrode 173b, and the second drain electrode 175b collectively define a second thin film transistor, which is a second switching element Qb, together with the second semiconductor 154b, and a channel of the second thin film transistor is formed in the second semiconductor 154b between the second source electrode 173b and the second drain electrode 175b. The third gate electrode 124c, the third source electrode 173c and the third drain electrode 175c collectively define the third thin film transistor, which is a third switching element Qc, together with the third semiconductor 154c, and a channel of the third thin film transistor is formed in the third semiconductor 154c between the third source electrode 173c and the third drain electrode 175c. In such an embodiment, the fourth gate electrode 124d, the fourth source electrode 173d and the fourth drain electrode 175d collectively define a fourth thin film transistor, which is a fourth switching element Qd, together with the fourth semiconductor 154d, and a channel of the fourth thin film transistor is formed in the fourth semiconductor 154d between the fourth source electrode 173d and the fourth drain electrode 175d.

The third drain electrode 173c includes an extended portion 176, which is downwardly elongated, and the third drain electrode 173c and the fourth source electrode 173d are connected to each other.

A first passivation layer 180a is disposed on the data conductors 171, 173a, 173b, 173c, 173d, 175a, 175b, 175c and 175d, and exposed portions of the semiconductors 154a, 154b, 154c and 154d. The first passivation layer 180a may include an inorganic insulating layer such as silicon nitride or silicon oxide, for example. The first passivation layer 180a may effectively prevent a pigment of a color filter 230 from flowing in the exposed portions of the semiconductors 154a, 154b, 154c and 154d.

The color filter 230 is disposed on the first passivation layer 180a.

A second passivation layer 180b is disposed on the color filter 230.

The second passivation layer 180b may include an inorganic insulating layer such as silicon nitride or silicon oxide, for example. The second passivation layer 180b effectively prevents the color filter 230 from being loosed and substantially reduces the contamination of the liquid crystal layer 3 due to an organic material, such as a solvent which inflows from the color filter 230, such that the residual image, which may be caused at the time of driving a screen, may be effectively prevented.

In such an embodiment, a first contact hole 185a, a second contact hole 185b and a third contact hole 185c are defined, e.g., formed, in the first passivation layer 180a, the color filter 230 and the second passivation layer 180b to expose the first drain electrode 175a, the second drain electrode 175b and the third drain electrode 175c.

A fourth contact hole 185d, which exposes a portion of the reference electrode 134 and a portion of the fourth drain electrode 175d, is defined in the first passivation layer 180a, the color filter 230, the second passivation layer 180b and the gate insulating layer 140, and a connecting member 195 covers the fourth contact hole 185d. The connecting member 195 electrically connects the reference electrode 134 and the fourth drain electrode 175d, which are exposed through the fourth contact hole 185d.

A plurality of pixel electrodes 191 is disposed on the second passivation layer 180b. The pixel electrodes 191 are spaced apart from the gate line 121 disposed therebetween, and each of the pixel electrodes 191 includes a first sub-pixel electrode 191a, a second sub-pixel electrode 191b and a third sub-pixel electrode 191c, which are adjacent to each other in a column direction with respect to the gate line 121.

The third sub-pixel electrode 191c is disposed adjacent to the second sub-pixel electrode 191b in the column direction. In such an embodiment, the first sub-pixel electrode 191a, the second sub-pixel electrode 191b and the third sub-pixel electrode 191c are disposed along a line in the column direction.

The pixel electrodes 191 may include a transparent material such as indium tin oxide (“ITO”) and indium zinc oxide (“IZO”). In one exemplary embodiment, for example, the pixel electrodes 191 may include a transparent conductive material such as ITO or IZO or a reflective metal such as aluminum, silver, chromium or an alloy thereof.

A first alignment layer (not illustrated) may be disposed on the pixel electrode 191.

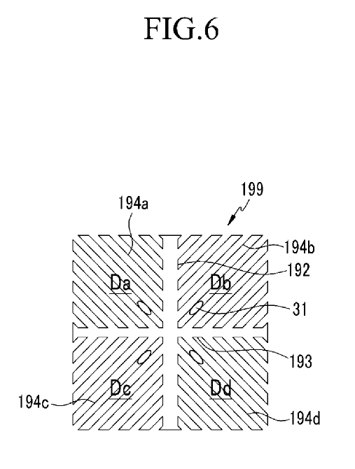

Each of the first sub-pixel electrode 191a, the second sub-pixel electrode 191b and the third sub-pixel electrode 191c includes a unit electrode 199 shown in FIG. 6 or one or more modification thereof.

The first sub-pixel electrode 191a, the second sub-pixel electrode 191b and the third sub-pixel electrode 191c are physically and electrically connected to the first drain electrode 175a, the second drain electrode 175b and the third drain electrode 175c, respectively, through the first contact hole 185a, the second contact hole 185b and the third contact hole 185c. The first sub-pixel electrode 191a and the second sub-pixel electrode 191b receive the data voltage applied from the first drain electrode 175a and the second drain electrode 175b. In such an embodiment, a portion of the data voltage, which is applied to the second drain electrode 175b, is divided by the third source electrode 173c, and a portion of the voltage which is applied to the third drain electrode 175c is divided by the fourth source electrode 173d.

Therefore, the voltage applied to the first sub-pixel electrode 191a is higher than the voltage applied to the second sub-pixel electrode 191b, and the voltage applied to the second sub-pixel electrode 191b is higher than the voltage applied to the third sub-pixel electrode 191c.

In an exemplary embodiment, as described above, the first sub-pixel electrode 191a, the second sub-pixel electrode 191b and the third sub-pixel electrode 191c, to which voltages having different values are applied, generate an electric field together with the common electrode 270 of the upper panel 200 to determine the direction of the liquid crystal molecules of the liquid crystal layer 3 between the pixel and common electrodes 191 and 270. Accordingly, in such an embodiment, the luminance of the light which passes through the liquid crystal layer 3 varies based on the direction of the liquid crystal molecules which is determined as described above.

In an exemplary embodiment, a light blocking member (not shown) may be disposed in the lower panel 100.

Now, the upper panel 200 will be described in detail.

In the upper panel 200, the common electrode 270 is disposed on a second insulation substrate 210. A second alignment layer (not illustrated) is disposed on the common electrode 270.

The first alignment layer and the second alignment layer may be vertical alignment layers.

The liquid crystal layer 3 has a negative dielectric anisotropy, and the liquid crystal molecules 31 of the liquid crystal layer 3 are aligned such that longitudinal axes thereof are substantially vertical to the surfaces of the two display panels 100 and 200 in a state where no electric field is applied.

As described above, in an exemplary embodiment of the liquid crystal display according to the invention, each of the pixel electrodes 191 includes the first sub-pixel electrode 191a, the second sub-pixel electrode 191b and the third sub-pixel electrode 191c, to which voltages having different values, are applied such that electric fields having different values are applied to the liquid crystal molecules 31 corresponding to the first sub-pixel electrode, the second sub-pixel electrode and the third sub-pixel electrode, and inclination angles of the liquid crystal molecule 31 are thereby substantially different from each other, which may vary the luminance of the regions. Therefore, in such an embodiment, a pixel area is divided into three regions having different luminances, such that the change in the transmittance in accordance with the gray scale is gradually controlled, and the transmittance is thereby effectively prevented from being sharply changed in accordance with the change of the gray scale at the side. Therefore, the gray scale may be accurately represented while allowing the side visibility to be close to the front visibility. In such an embodiment, a single data line is used to apply a data signal to one pixel area such that a cost for the data driver may be substantially reduced.

Now, an exemplary embodiment of the unit electrode 199 will be described with reference to FIG. 6.

As illustrated in FIG. 6, an overall shape of the unit electrode 199 is a quadrangle, and the unit electrode 199 includes a cross-shaped stem portion including a horizontal stem portion 193 and a vertical stem portion 192, which is substantially perpendicular to the horizontal stem portion 193. In such an embodiment, the unit electrode 199 is divided into a first sub-region Da, a second sub-region Db, a third sub-region Dc and a fourth sub-region Dd by the horizontal stem portion 193 and the vertical stem portion 192. The first to fourth sub-regions Da to Dd include a plurality of first minute branch portions 194a, a plurality of second minute branch portions 194b, a plurality of third minute branch portions 194c and a plurality of fourth minute branch portions 194d, respectively.

In an exemplary embodiment, as shown in FIG. 6, the first minute branch portions 194a obliquely extends in a left-upper direction from the horizontal stem portion 193 or the vertical stem portion 192, and the second minute branch portions 194b obliquely extends in a right-upper direction from the horizontal stem portion 193 or the vertical stem portion 192. In such an embodiment, the third minute branch portions 194c extends in a left-down direction from the horizontal stem portion 193 or the vertical stem portion 192, and the fourth minute branch portions 194d obliquely extends in a right-down direction from the horizontal stem portion 193 or the vertical stem portion 192.

The first to fourth minute branch portions 194a, 194b, 194c and 194d form an angle of about 45 degrees or about 135 degrees with the gate line 121a and 121b or the horizontal stem portion 193. In such an embodiment, the minute branch portions 194a, 194b, 194c and 194d of the two adjacent sub-regions of the sub-regions Da to Dd may be substantially perpendicular to each other.

In such an embodiment, when a voltage is applied to the first sub-pixel electrode 191a, the second sub-pixel electrode 191b and the third sub-pixel electrode 191c, sides of the first to fourth minute branch portions 194a, 194b, 194c and 194d determines a direction of a horizontal component of the electric field, which determines an inclined direction of the liquid crystal molecules 31. The horizontal component of the electric field is substantially horizontal to the sides of the first to fourth minute branch portions 194a, 194b, 194c and 194d. Accordingly, as illustrated in FIG. 6, the liquid crystal molecules 31 are inclined in a direction which is substantially parallel to a length direction of the minute branch portions 194a, 194b, 194c and 194d. Each unit electrode 199 includes four sub-regions Da to Dd, in which length directions of the minute branch portions 194a, 194b, 194c and 194d are different from each other, such that the liquid crystal molecules 31 are inclined substantially in four directions, and four domains having different alignment directions of the liquid crystal molecules 31 are defined in the liquid crystal layer 3. As described above, in such an embodiment, where the inclined directions of the liquid crystal molecules varies, a reference viewing angle of the liquid crystal display is substantially increased.

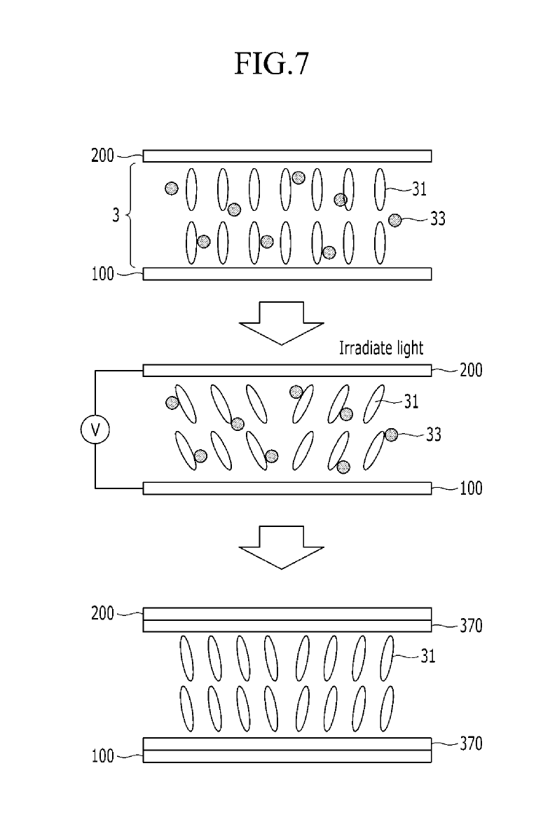

Now, an exemplary embodiment of a method of providing initially alignment of the liquid crystal molecule 31 to be pre-tilted will be described with reference to FIG. 7.

FIG. 7 is a diagram illustrating an exemplary embodiment of a process that allows the liquid crystal molecules to be pre-tilted using a prepolymer which is polymerized by light such as ultraviolet rays.

First, a prepolymer 33 such as a monomer, which is hardened by polymerization by the light such as an ultraviolet ray, is injected between the two display panels 100 and 200 together with the liquid crystal material. In one exemplary embodiment, for example, the prepolymer 33 may be a reactive mesogen, which is polymerized by the light such as the ultraviolet ray.

A voltage is applied to the first sub-pixel electrode 191a, the second sub-pixel electrode 191b and the third sub-pixel electrode 191c, and a common voltage is applied to the common electrode 270 of the upper panel 200 to generate an electric field in the liquid crystal layer 3 between the two display panels 100 and 200, such that the liquid crystal molecules 31 of the liquid crystal layer 3 are inclined in a direction which is substantially parallel to the length direction of the minute branch portions 194a, 194b, 194c and 194d based on the electric field generated between the pixel and common electrodes 191 and 270, as described above and the liquid crystal molecules 31 may be inclined in four directions in the pixel.

When light such as the ultraviolet ray is irradiated onto the liquid crystal layer 3 after generating the electric field in the liquid crystal layer 3, the prepolymer 33 is polymerized to form a polymer 370 as illustrated in FIG. 7. The ultraviolet ray is irradiated onto the liquid crystal layer 3 while the electric field is generated in the liquid crystal layer 3. The polymer 370 is formed to be in contact with the display panels 100 and 200. The alignment direction of the liquid crystal molecules 31 is determined by the polymer 370 such that the liquid crystal molecules 31 are pre-tilted in a direction described above. Accordingly, even when the voltage is not applied to the field generating electrodes, e.g., pixel and common electrodes 191 and 270, the liquid crystal molecules 31 are aligned to be pre-tilted in four different directions.

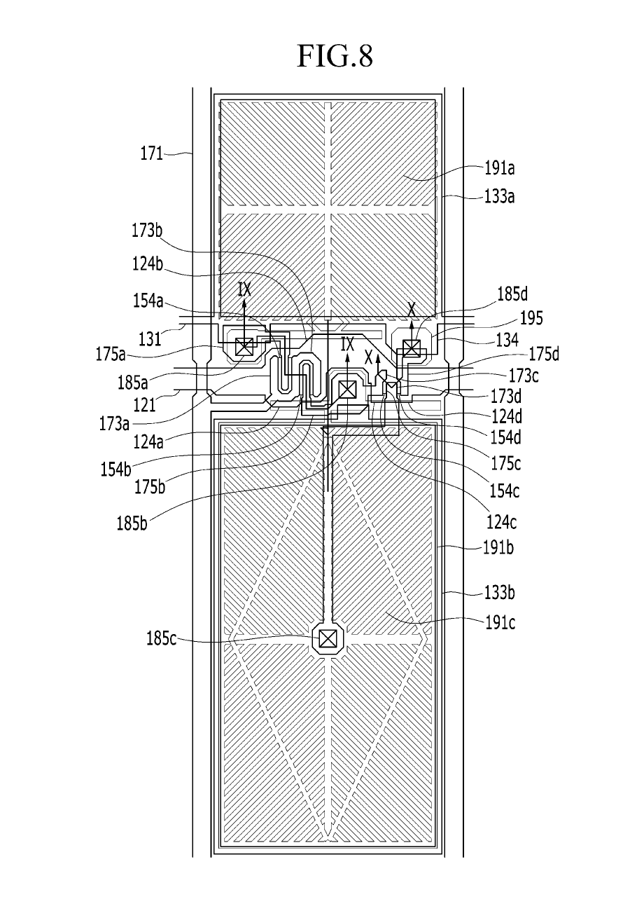

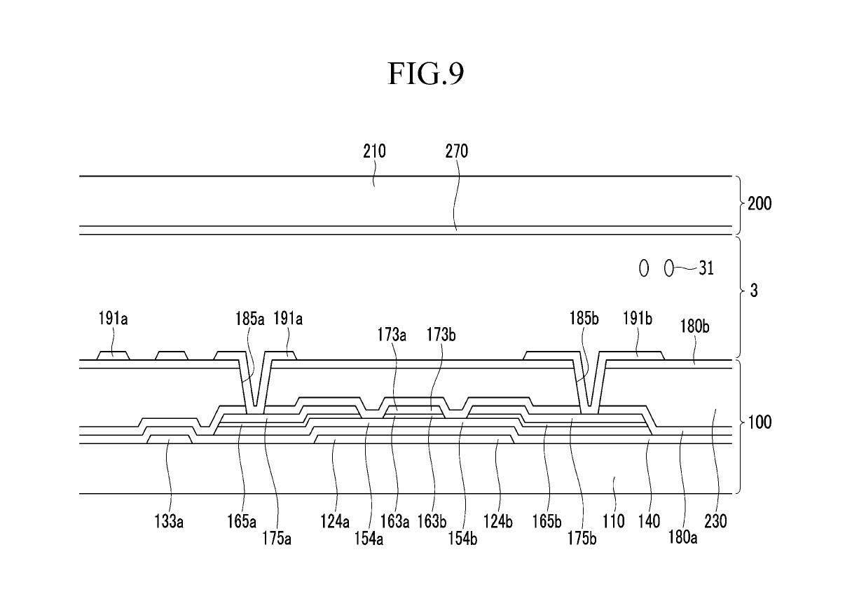

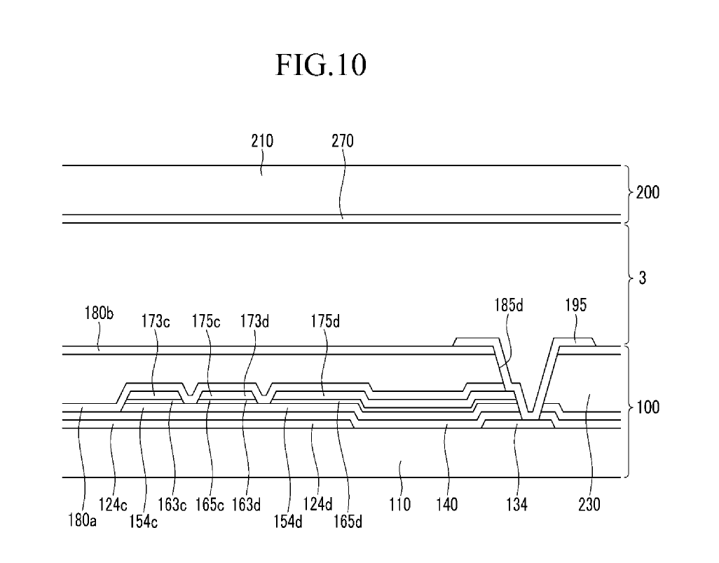

Now, a structure of an alternative exemplary embodiment of the liquid crystal display, according to the invention, will be described with reference to FIGS. 8 to 10. FIG. 8 is a top plan view of an alternative exemplary embodiment of a liquid crystal display, according to the invention, FIG. 9 is a cross-sectional view taken along line IX-IX of the liquid crystal display shown in FIG. 8, and FIG. 10 is a cross-sectional view taken along line X-X of the liquid crystal display shown in FIG. 8.

The exemplary embodiment of the liquid crystal display shown in FIGS. 8 to 10 is substantially similar to the exemplary embodiment of the liquid crystal display illustrated in FIGS. 3 to 5.

Referring to FIGS. 8 to 10, an exemplary embodiment of the liquid crystal display includes two display panels, e.g., a lower panel 100 and an upper panel 200, which oppose to each other, a liquid crystal layer 3 interposed between the two display panels 100 and 200, and a pair of polarizers (not illustrated) which is attached to outer surfaces of the two display panel 100 and 200.

First, the lower panel 100 will be described in detail.

In the lower panel 100, a gate conductor which includes a gate line 121 and a dividing reference voltage line 131 is disposed on a first insulation substrate 110 which includes a transparent material such as glass or plastic, for example.

The gate line 121 includes a first gate electrode 124a, a second gate electrode 124b, a third gate electrode 124c, a fourth gate electrode 124d and a gate pad (not illustrated) for connection with another layer or an external driving circuit.

The dividing reference voltage line 131 includes a first storage electrode 133a and a reference electrode 134. A second storage electrode 133b which is not connected to the dividing reference voltage line 131 and overlaps a second sub-pixel electrode 191b, is disposed on the first insulation substrate 110.

A gate insulating layer 140 is disposed on the gate line 121 and the dividing reference voltage line 131.

A first semiconductor 154a, a second semiconductor 154b, a third semiconductor 154c and a fourth semiconductor 154d are disposed on the gate insulating layer 140.

A plurality of ohmic contacts 163a, 165a, 163b, 165b, 163c, 165c, 163d and 165d is disposed on the semiconductors 154a, 154b, 154c and 154d.

A plurality of data conductors including a plurality of data lines 171, which includes a first source electrode 173a and a second source electrode 173b, a first drain electrode 175a, a second drain electrode 175b, a third source electrode 173a, the third drain electrode 175c, a fourth source electrode 173d and a fourth drain electrode 175d, is disposed on the ohmic contacts 163a, 165a, 163b, 165b, 163c, 165c, 163d and 165d and the gate insulating layer 140.

The data line 171 includes a data pad (not illustrated) for connection with another layer or an external driving circuit.

The third drain electrode 173c includes an extended portion 176 which is downwardly elongated, and the third drain electrode 173c and the fourth source electrode 173d are connected to each other.

A first passivation layer 180a is disposed on the data conductors 171, 173a, 173b, 173c, 173d, 175a, 175b, 175c and 175d, and exposed portions of the semiconductors 154a, 154b, 154c and 154d.

The color filter 230 is disposed on the first passivation layer 180a.

A second passivation layer 180b is disposed on the color filter 230. In such an embodiment, a first contact hole 185a, a second contact hole 185b, and a third contact hole 185c are defined in the first passivation layer 180a, the color filter 230 and the second passivation layer 180b to expose the first drain electrode 175a, the second drain electrode 175b and the third drain electrode 175c.

A fourth contact hole 185d, which exposes a portion of the reference electrode 134 and a portion of the fourth drain electrode 175d, is defined in the first passivation layer 180a, the color filter 230, the second passivation layer 180b and gate insulating layer 140, and a connecting member 195 covers the fourth contact hole 185d. The connecting member 195 electrically connects the reference electrode 134 and the fourth drain electrode 175d, which are exposed through the fourth contact hole 185d.

A plurality of pixel electrodes 191 is disposed on the second passivation layer 180b. The pixel electrodes 191 are spaced apart from the gate line 121 therebetween, and each of the pixel electrodes 191 includes a first sub-pixel electrode 191a and a second sub-pixel electrode 191b, which are adjacent to each other in a column direction, with respect to the gate line 121 and a third sub-pixel electrode 191c, which is disposed in a region surrounded by the second sub-pixel electrode 191b.

In an exemplary embodiment, the second sub-pixel electrode 191b includes a stem portion disposed in or defines an edge thereof, and a plurality of minute branch portions which extends from the stem portion in a direction substantially the same as the plurality of first to fourth minute branch portions of the unit electrode 199 illustrated in FIG. 6. An overall shape of the second sub-pixel electrode 191b is a shape collectively defined by four right triangles, and an overall shape of the third sub-pixel electrode 191c is a rhombus. The third sub-pixel electrode 191c is enclosed by the second sub-pixel electrode 191b.

Each of the first sub-pixel electrode 191a and the third sub-pixel electrode 191c includes the unit electrode 199 illustrated in FIG. 6 or one or more modifications thereof.

A first alignment layer (not illustrated) may be formed on the pixel electrode 191.

The first sub-pixel electrode 191a, the second sub-pixel electrode 191b and the third sub-pixel electrode 191c are physically and electrically connected to the first drain electrode 175a, the second drain electrode 175b and the third drain electrode 175c, respectively, through the first contact hole 185a, the second contact hole 185b and the third contact hole 185c. The first sub-pixel electrode 191a and the second sub-pixel electrode 191b receive the data voltage applied from the first drain electrode 175a and the second drain electrode 175b. In such an embodiment, a portion of the data voltage applied to the second drain electrode 175b is divided by the third source electrode 173c, and a portion of the voltage applied to the third drain electrode 175c is divided by the fourth source electrode 173d.

Therefore, the voltage applied to the first sub-pixel electrode 191a is higher than the voltage applied to the second sub-pixel electrode 191b and the voltage applied to the second sub-pixel electrode 191b is higher than the voltage applied to the third sub-pixel electrode 191c.

In an exemplary embodiment, as described above, the first sub-pixel electrode 191a, the second sub-pixel electrode 191b and the third sub-pixel electrode 191c, to which voltages having different values are applied, generate an electric field together with the common electrode 270 of the upper panel 200 to determine the direction of the liquid crystal molecules of the liquid crystal layer 3 between the pixel and common electrodes 191 and 270. Accordingly, in such an embodiment, the luminance of the light which passes through the liquid crystal layer 3 varies based on the direction of the liquid crystal molecules which is determined as described above.

In an exemplary embodiment, a light blocking member (not shown) may be disposed in the lower panel 100.

Now, the upper panel 200 will be described in detail.

The common electrode 270 is disposed on a second insulation substrate 210. A second alignment layer (not illustrated) is disposed on the common electrode 270.

The first alignment layer and the second alignment layer may be vertical alignment layers.

The liquid crystal layer 3 has a negative dielectric anisotropy, and the liquid crystal molecules 31 of the liquid crystal layer 3 are aligned such that longitudinal axes thereof are substantially vertical to the surfaces of the two display panels 100 and 200 in a state where no electric field is applied.

In an exemplary embodiment of the liquid crystal display, as shown in FIGS. 8 to 10, the pixel electrode 191 is spaced apart from the gate line 121 therebetween, and each of the pixel electrodes 191 includes the first sub-pixel electrode 191a and the second sub-pixel electrode 191b which are adjacent in a column direction with respect to the gate line 121 and the third sub-pixel electrode 191c which is formed in the second sub-pixel electrode 191b. The second sub-pixel electrode has a shape in which four right triangles are put together and the third sub-pixel electrode 191c has a rhombus shape. The third sub-pixel electrode 191c is enclosed by the second sub-pixel electrode 191b.

As described above, according to the liquid crystal display according to the exemplary embodiment of the invention, each of the pixel electrodes 191 includes the first sub-pixel electrode 191a, the second sub-pixel electrode 191b and the third sub-pixel electrode 191c, to which voltages having different values are applied, such that electric fields having different values are applied to the liquid crystal molecules corresponding to the first sub-pixel electrode, the second sub-pixel electrode and the third sub-pixel electrode, and the inclination angles of the liquid crystal molecule are variously determined, which may vary the luminance of the regions. Therefore, in such an embodiment, one pixel area is divided into three regions having different luminances, and the change in the transmittance in accordance with the gray scale is thereby gradually controlled such that the transmittance is effectively prevented from being sharply changed in accordance with the change of the gray scale at the side. Therefore, the gray scale may be accurately represented while allowing the side visibility to be close to the front visibility. In such an embodiment, one data line is used to apply a data signal to one pixel area such that a cost for the data driver may be substantially reduced.

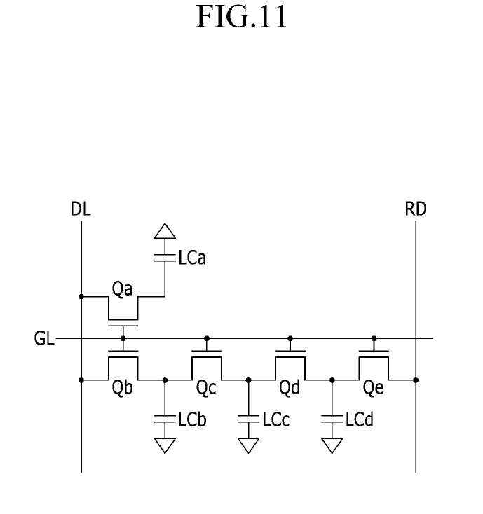

Now, another alternative exemplary embodiment of a liquid crystal display according to the invention will be described with reference to FIG. 11.

FIG. 11 is an equivalent circuit diagram of a pixel of an alternative exemplary embodiment of a liquid crystal display, according to the invention.

The exemplary embodiment of the liquid crystal display illustrated in FIG. 11 is substantially similar to the exemplary embodiment of the liquid crystal display illustrated in FIG. 1.

Referring to FIG. 11, a pixel of an exemplary embodiment of the liquid crystal display includes a plurality of signal lines, which includes a gate line GL that transmits a gate signal, a data line DL that transmits a data signal, and a dividing reference voltage line RD that transmits a divided reference voltage, a first switching element Qa, a second switching element Qb, a third switching element Qc, a fourth switching element Qd and a fifth switching element Qe, which are connected to the plurality of signal lines, and a first liquid crystal capacitor LCa, a second liquid crystal capacitor LCb, a third liquid crystal capacitor LCc and a fourth liquid crystal capacitor LCd.

The first switching element Qa and the second switching element Qb are connected to the gate line GL and data line DL, respectively. The third switching element Qc is connected to the gate line GL and an output terminal of the second switching element Qb, the fourth switching element Qd is connected to the gate line GL and the output terminal of the third switching element Qc, and the fifth switching element Qe is connected to the gate line GL and the dividing reference voltage line RD.

The first switching element Qa and the second switching element Qb are three terminal elements such as a thin film transistor, and a control terminal thereof is connected to the gate line GL and an input terminal thereof is connected to the data line DL. An output terminal of the first switching element Qa is connected to the first liquid crystal capacitor LCa, and an output terminal of the second switching element Qb is connected to the second liquid crystal capacitor LCb and an input terminal of the third switching element Qc. An output terminal of the third switching element Qc is connected to the third liquid crystal capacitor LCc and an input terminal of the fourth switching element Qd, and an output terminal of the fourth switching element is connected to the fourth liquid crystal capacitor LCd and an input terminal of the fifth switching element Qe. An output terminal of the fifth switching element Qe is connected to the dividing reference voltage line RD.

In such an embodiment, the liquid crystal display includes four liquid crystal capacitors LCa, LCb, LCc and LCd, and voltages charged in the four liquid crystal capacitors LCa, LCb, LCc and LCd have different values.

Therefore, in such an embodiment, a pixel area is divided into four regions having different luminances, and the change in the transmittance in accordance with the gray scale is thereby gradually controlled such that the transmittance is effectively prevented from being sharply changed in accordance with the change of the gray scale at the side. Therefore, the gray scale may be accurately represented while allowing the side visibility to be close to the front visibility.

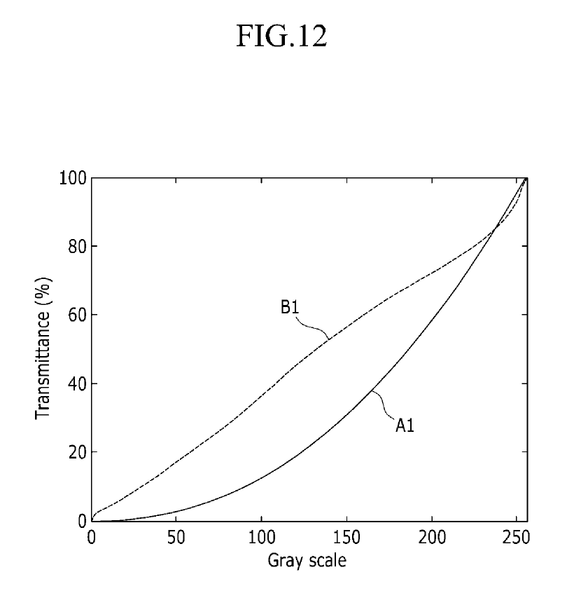

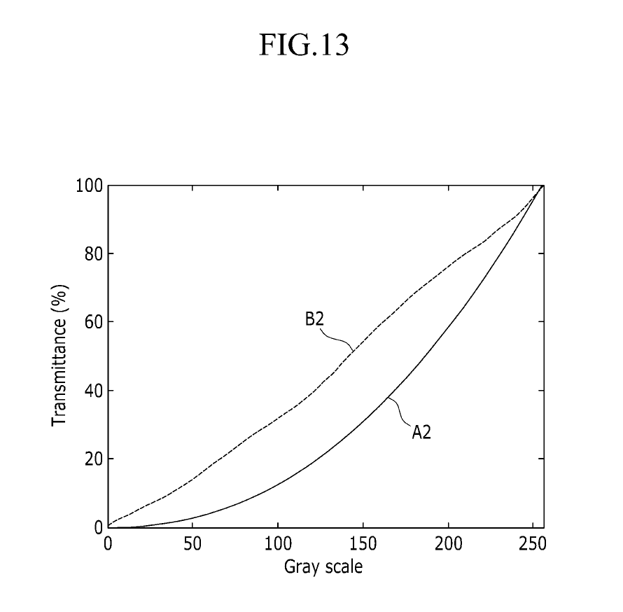

Now, an experimental example will be described with respect to FIGS. 12 and 13. FIGS. 12 and 13 are graphs illustrating a result of an experimental example of a conventional liquid crystal display and an exemplary embodiment of a liquid crystal display according to the invention, respectively.

In the experimental example, in the conventional liquid crystal display, a pixel area is defined to be divided into a first sub-pixel electrode and a second sub-pixel electrode, and a voltage-dividing switching element is connected to an output terminal of the second sub-pixel electrode and a second case. In the exemplary embodiment of the liquid crystal display according to the invention, a pixel area is defined to be divided into the first sub-pixel electrode, the second sub-pixel electrode and the third sub-pixel electrode, and voltages of the second sub-pixel electrode and the third sub-pixel electrode are divided using the voltage-dividing switching element. In the experimental example, the change in the transmittance in accordance with the gray scale is measured in the front and the side of each of the conventional liquid crystal display and the exemplary embodiment of a liquid crystal display according to the invention, and the results thereof are illustrated in FIGS. 12 and 13.

FIG. 12 is a graph illustrating the change in the transmittance in accordance with the gray scale in the front and the side of the conventional liquid crystal display, in which A1 is a graph illustrating the change in the transmittance in accordance with the gray scale in the front and B1 is a graph illustrating the change in the transmittance in accordance with the gray scale in the side.

FIG. 13 is a graph illustrating the change in the transmittance in accordance with the gray scale in the front and the side of the exemplary embodiment of the liquid crystal display, in which A2 is a graph illustrating the change in the transmittance in accordance with the gray scale in the front and B2 is a graph illustrating the change in the transmittance in accordance with the gray scale in the side.

Referring to FIG. 12, in the conventional liquid crystal display, the difference between the transmittance in the front and the transmittance in the side is substantially great at an intermediate gray scale, for example, at about 130 gray scales to about 180 gray scales, that is, the transmittance is hardly changed in accordance with the change in the gray scales at a high gray scale, particularly, at about 250 gray scales and then the transmittance is sharply changed thereafter as the gray scales changes.

Referring to FIG. 13, in the exemplary embodiment of the liquid crystal display according to the invention, the difference between the transmittance in the front and the transmittance in the side is substantially reduced as compared with the conventional liquid crystal display at an intermediate gray scale, for example, at about 130 gray scales to about 180 gray scales and the transmittance is gradually changed at a high gray scale, particularly, at about 250 gray scales thereafter as the gray scales changes.

As described above, in an exemplary embodiment of the liquid crystal display according the invention, a pixel area is divided into the first sub-pixel electrode, the second sub-pixel electrode and the third sub-pixel electrode, and the voltages of the second sub-pixel electrode and the third sub-pixel electrode are divided by the voltage-dividing switching element, such that the side visibility becomes substantially close to the front visibility.

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display, comprising:
a first insulation substrate;
a gate line disposed on the first insulation substrate;
a dividing reference voltage line disposed on the first insulation substrate;
a data line disposed on the first insulation substrate;
a first switching element connected to the gate line, the data line and a first liquid crystal capacitor;
a second switching element connected to the gate line, the data line and a second liquid crystal capacitor;
a third switching element connected to the gate line, the second liquid crystal capacitor and a third liquid crystal capacitor; and
a fourth switching element connected to the gate line, the third liquid crystal capacitor and the dividing reference voltage line.

2. The liquid crystal display of claim 1, wherein
a control terminal of the third switching element is connected to the gate line,
an input terminal of the third switching element is connected to the second liquid crystal capacitor,
an output terminal of the third switching element is connected to the third liquid crystal capacitor,
a control terminal of the fourth switching element is connected to the gate line,
an input terminal of the fourth switching element is connected to the third liquid crystal capacitor, and
an output terminal of the fourth switching element is connected to the dividing reference voltage line.

3. The liquid crystal display of claim 2, wherein
a control terminal of the first switching element is connected to the gate line,
an input terminal of the first switching element is connected to the data line,
an output terminal of the first switching element is connected to the first liquid crystal capacitor,
a control terminal of the second switching element is connected to the gate line,
an input terminal of the second switching element is connected to the data line, and
an output terminal of the second switching element is connected to the second liquid crystal capacitor.

4. The liquid crystal display of claim 2, further comprising:
a fifth switching element connected between the gate line, the second liquid crystal capacitor and the third liquid crystal capacitor,
wherein
a control terminal of the fifth switching element is connected to the gate line,
an input terminal of the fifth switching element is connected to the second liquid crystal capacitor, and
an output terminal of the fifth switching element is connected to a fourth liquid crystal capacitor and the input terminal of the fourth switching element.

5. A liquid crystal display, comprising:
a first insulation substrate;
a gate line disposed on the first insulation substrate;
a dividing reference voltage line disposed on the first insulation substrate;
a gate insulating layer disposed on the gate line and the dividing reference voltage line;
a first semiconductor, a second semiconductor, a third semiconductor, and a fourth semiconductor disposed on the gate insulating layer;
a data line comprising a first source electrode, a first drain electrode, a second source electrode, a second drain electrode, a third source electrode, a third drain electrode, a fourth source electrode and a fourth drain electrode, which are disposed on the first semiconductor, the second semiconductor, the third semiconductor and the fourth semiconductor;
an insulating layer disposed on the data line, the first drain electrode, the second drain electrode, the third source electrode, the third drain electrode, the fourth source electrode and the fourth drain electrode;
a pixel electrode disposed on the insulating layer, wherein the pixel electrode comprises:
a first sub-pixel electrode connected to the first drain electrode;
a second sub-pixel electrode connected to the second drain electrode; and
a third sub-pixel electrode connected to the third drain electrode;
a second insulation substrate disposed opposite to the first insulation substrate; and
a common electrode disposed on the second insulation substrate.

6. The liquid crystal display of claim 5, wherein
the second drain electrode and the third source electrode are connected to each other,
the third drain electrode and the fourth source electrode are connected to each other.

7. The liquid crystal display of claim 6, wherein
the dividing reference voltage line comprises a reference electrode, and
the fourth drain electrode and the reference electrode are connected to each other.

8. The liquid crystal display of claim 7, wherein
the first sub-pixel electrode, the second sub-pixel electrode and the third sub-pixel electrode are sequentially arranged in a direction substantially parallel to the data line.

9. The liquid crystal display of claim 8, wherein
each of the first sub-pixel electrode, the second sub-pixel electrode and the third sub-pixel electrode comprises a cross-shaped stem portion, and a plurality of fine branch electrodes extending in a plurality of directions from the cross-shaped stem portion.

10. The liquid crystal display of claim 7, wherein
the first sub-pixel electrode is spaced apart from the second sub-pixel electrode and the third sub-pixel electrode,
the third sub-pixel electrode has a rhombus shape in a plan view, and
the second sub-pixel electrode encloses the third sub-pixel electrode.

11. The liquid crystal display of claim 10, wherein
each of the first sub-pixel electrode and the third sub-pixel electrode comprises a cross-shaped stem portion, and a plurality of fine branch electrodes extending in a plurality of directions from the cross-shaped stem portion, and
the second sub-pixel electrode comprises a stem electrode disposed at an edge thereof, and a plurality of fine branch electrodes extending in a plurality of directions from the stem electrode.

12. The liquid crystal display of claim 5, wherein
the dividing reference voltage line comprises a reference electrode, and
the fourth drain electrode and the reference electrode are connected to each other.

13. The liquid crystal display of claim 12, wherein
the first sub-pixel electrode, the second sub-pixel electrode and the third sub-pixel electrode are sequentially disposed in a direction substantially parallel to the data line.

14. The liquid crystal display of claim 13, wherein
each of the first sub-pixel electrode, the second sub-pixel electrode and the third sub-pixel electrode comprises a cross-shaped stem portion, and a plurality of fine branch electrodes extending in a plurality of directions from the cross-shaped stem portion.

15. The liquid crystal display of claim 12, wherein
the first sub-pixel electrode is spaced apart from the second sub-pixel electrode and the third sub-pixel electrode,
the third sub-pixel electrode has a rhombus shape in a plan view, and
the second sub-pixel electrode encloses the third sub-pixel electrode.

16. The liquid crystal display of claim 15, wherein
each of the first sub-pixel electrode and the third sub-pixel electrode comprises a cross-shaped stem portion, and a plurality of fine branch electrodes extending in a plurality of directions from the cross-shaped stem portion, and
the second sub-pixel electrode comprises a stem electrode disposed at an edge thereof, and a plurality of fine branch electrodes extending in a plurality of directions from the stem electrode.

17. The liquid crystal display of claim 5, wherein
the first sub-pixel electrode, the second sub-pixel electrode, and the third sub-pixel electrode are sequentially disposed in a direction substantially parallel to the data line.

18. The liquid crystal display of claim 17, wherein
each of the first sub-pixel electrode, the second sub-pixel electrode and the third sub-pixel electrode comprises a cross-shaped stem portion, and a plurality of fine branch electrodes extending in a plurality of directions from the cross-shaped stem portion.

19. The liquid crystal display of claim 5, wherein
the first sub-pixel electrode is spaced apart from the second sub-pixel electrode and the third sub-pixel electrode, and
the third sub-pixel electrode has a rhombus shape in a plan view, and
the second sub-pixel electrode encloses the third sub-pixel electrode.

20. The liquid crystal display of claim 19, wherein
each of the first sub-pixel electrode and the third sub-pixel electrode comprises a cross-shaped stem portion, and a plurality of fine branch electrodes extending in a plurality of directions from the cross-shaped stem portion, and
the second sub-pixel electrode comprises a stem electrode disposed at an edge thereof, and a plurality of fine branch electrodes extending in a plurality of directions from the stem electrode.
